(19) United States
(12) Patent Application Publication
(10) Pub. No.: US 2026/0237376 A1
(43) Pub. Date: Aug. 13, 2026

(54) DEVICE FOR RECREATING A SOUND REVERBERATION EFFECT AND PROVIDED WITH A MEMS SPRING

(71) Applicant: COMMISSARIAT A L'ENERGIE ATOMIQUE ET AUX ENERGIES ALTERNATIVES, Paris (FR)

(72) Inventor: Romain LIECHTI, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/988,481

(22) Filed: Dec. 19, 2024

(30) Foreign Application Priority Data
Dec. 22, 2023 (FR) FR2315181

(51) Int. Cl. G10K 15/08

(52) U.S. Cl. CPC G10K 15/08

(57) ABSTRACT

A micro-electromechanical device or distorting an electrical signal to recreate a sound reverberation effect including:
an input connector for an incoming electrical signal;
an output connector for an outgoing electrical signal;
an input electromechanical transducer coupled to the input connector;
an output electromechanical transducer coupled to the output connector;
a support structure;
said device being provided with a MEMS spring including a first end, a second end, the first end and the second end being connected respectively to the input electromechanical transducer by means of a hinge to the output electromechanical transducer by means of another hinge, the input electromechanical transducer, the output electromechanical transducer and the hinges being partially embedded on the support structure, the input electromechanical transducer being configured to move the hinge.

### TECHNICAL FIELD

The present invention belongs to the technical field of microelectromechanical systems (MEMS).

The invention relates more particularly to a miniaturized spring allowing recreating the reverberation effect which is naturally present and in particular in large rooms. The invention finds a direct application in the musical field and allows developing sound effects in an analogue and compact manner.

### PRIOR ART

The search for sound effects, whether by exploiting the acoustics of particular places or the rendering obtained by the use of certain materials or objects for example, constitutes a subject of constant development.

Used both by musicians and sound designers, sound effects, whether analogue or digital, are constantly being invented in order to explore new fields and contribute to pushing the boundaries of creativity.

A well-known effect is that of the reverberation naturally present in concert halls, recording studios, and other performance venues, places in which the walls will reflect incident acoustic waves with a loss in amplitude which depends on the type of materials used.

Thus, reflected acoustic waves will be juxtaposed and arrive with a certain delay near the listeners (or sound capture systems), thus creating an immersive sound experience.

There are several techniques that can artificially reproduce this reverberation effect. First of all, echo chambers were developed at the beginning of the 20th century to reproduce reverberation in small volumes (recording studio, radio studio, etc.). Then came spring reverbs which allowed reproducing the desired effect. However, the obtained result was different from that of natural reverbs or echo chambers, making it a full-fledged effect with its own sound signature. In addition, and in order to obtain the desired effect, it is necessary for the springs to be long enough to obtain a delay between the different echoes.

On a principle similar to that of the springs, plate reverb was developed in the second half of the 20th century. This time, the sound is transmitted through a metal plate in which complex reflections take place. The sound rendering is then closer to the acoustics of halls having a significant reverberation.

However, the used plates are often heavy and bulky, not allowing easy use.

Then, with the development of transistors, the previously described devices could be replaced by fully electronic delay lines transmitting the analogue signal with a delay of up to several milliseconds.

Finally, the digital reverberation effects, which are mainly based on algorithms that recreate sound spaces, emerged. These effects allow simulating the acoustics of halls such as concert halls, recording studios, as well as other reverberation effects. In addition, they allow integrating these effects into compact elements, in comparison with the previously mentioned physical examples.

The document RAMIREZ, M. A. M. et al. Modeling plate and spring reverberation using a DSP-informed deep neural network, ICASSP 2020-2020 IEEE International Conference on Acoustics, Speech and Signal Processing, pages 241 to 245, describes a method for modelling the reverberation effects obtained in springs and plates. This modelling is based on a neural network to carry out in particular a deep learning of the nonlinear effects present in the spring and plate reverberations. However, this type of modelling is complex to implement, and the obtained results are an approximation of the physical phenomena present in these reverberation effects. The document BILBAO, S., Numerical simulation of spring reverberation, 16^{th} International Conference of Digital Audio Effects, September 2013, describes another type of modelling of the reverberation effect in springs and which is based on the calculation of Finite Difference Time Domain (FDTD) to model the vibration of helical springs. Again, it is difficult to model all physical effects that take place in this type of reverberation effect. These models, although complex, are therefore incomplete and it appears necessary to be particularly vigilant about their numerical stability in order to converge towards solutions.

The problem of developing a device allowing recreating a reverberation effect, which is compact while guaranteeing a highly faithful rendering of the desired sound effect, arises.

### DESCRIPTION OF THE INVENTION

The present invention aims at overcoming all or part of the previously presented drawbacks, and then proposes a device allowing recreating a reverberation effect, said device being equipped with a MEMS spring.

It is specified here that the term MEMS corresponds to the abbreviation of Microelectromechanical systems. The term “MEMS springs and cells”, and generally, means miniaturised components that can in particular be used with electronic circuits or be integrated into microelectronic devices and perform functions, which are equivalent to conventional components, therein.

According to one embodiment, the present invention relates to a micro-electromechanical device for distorting an electrical signal to recreate a sound reverberation effect including:
an input connector for an incoming electrical signal;
an output connector for an outgoing electrical signal;
an input electromechanical transducer coupled to the input connector;
an output electromechanical transducer coupled to the output connector;
a support structure;
   said device being provided with a MEMS spring including a first end, a second end, the first end and the second end being connected respectively to the input electromechanical transducer by means of a hinge to the output electromechanical transducer by means of another hinge, the input electromechanical transducer, the output electromechanical transducer and the hinges being partially embedded on the support structure, the input electromechanical transducer being configured to move the hinge.

The term “coupled” designates here an electrical connection or link that may be direct or that may be indirect (that is to say made through one or more electrical elements or intermediate components).

Advantageously, the input electromechanical transducer and/or the output electromechanical transducer include(s) two blades, in particular coplanar, configured to apply a torsional torque to the hinge.

Advantageously, the blades are piezoelectric elements.

According to a particular feature of the invention, the incoming electrical signal is transmitted on one of the blades of the input electromechanical transducer, while said incoming electrical signal is transmitted in phase opposition on the other blade of said transducer.

According to another particular feature of the invention, the hinge comprises a connecting rod connecting together one edge of a blade with another edge of the other blade and an embedding rod connecting the support structure to the connecting rod.

Advantageously, the MEMS spring is a flat spring, which when said spring is at rest, extends between the first end and the second end in the same plane.

Another particular feature is that the MEMS spring is formed of a succession of MEMS cells, each cell forming one or more corrugations, advantageously rectangular or triangular, the succession of cells forming a succession of corrugations.

Advantageously, each MEMS cell is defined by a thickness comprised between 5 and 20 μm, a band width comprised between 5 and 100 μm, a half-width comprised between 100 μm and 2 mm, and an interband spacing comprised between 5 and 20 μm.

Advantageously, the MEMS cells have dimensions which depend on their position along the MEMS spring.

Advantageously, the device further comprises at least one hermetic housing in which the support structure, the input and output transducers and the MEMS spring are housed, the pressure inside the housing being advantageously comprised between 0.1 Pa and 100 Pa.

Advantageously, the device further comprises: a printed circuit on which the support structure and an analogue processing circuit connected to the output connector are arranged.

Another subject of the invention is a sound production system comprising a micro-electromechanical device for recreating a reverberation effect.

Another subject of the invention is a method for manufacturing the micro-electromechanical device, comprising the following steps:
providing a support, comprising, from the rear face thereof to the front face thereof: at least one first semiconductor layer and a second semiconductor layer which are superimposed, and coating the support with a stack comprising a first conductive layer, a piezoelectric material layer and a second conductive layer,
structuring the stack and the second semiconductor layer of the support so as to produce the input and output transducer in said stack as well as the hinges and the MEMS spring in the second semiconductor layer,
etching the first semiconductor layer by the rear face of the support so as to release the MEMS spring, the hinges and the input and output transducers.

### PRESENTATION OF THE DRAWINGS

The figures are provided purely for illustrative purposes for a better understanding of the invention without limiting its scope. The different elements may be represented schematically and are not necessarily on the same scale. In all figures, the identical or equivalent elements bear the same reference numeral.

It is thus illustrated in:

FIG. 1: an exploded view of a device for recreating a reverberation effect, according to one embodiment of the invention;

FIG. 2: a perspective view of the device for recreating a reverberation effect;

FIG. 3A: a top view of a MEMS component of the device recreating a reverberation effect, according to a first embodiment;

FIG. 3B: a top view of a MEMS component of the device recreating a reverberation effect, according to a second embodiment;

FIG. 4: a top view of a transducer and a hinge of the MEMS component according to the first and second embodiments;

FIG. 5: a graph of an electrical signal of an impulse response obtained by means of the device;

FIG. 6: three perspective views of a transducer of the device recreating a reverberation effect when the transducer is: in its equilibrium position (A), in a vibration mode in phase opposition (B), in a vibration mode in phase (C);

FIG. 7: an electrical diagram of a differential amplifier assembly for extracting certain components of the signal produced by the device;

FIG. 8A, FIG. 8B, FIG. 8C and FIG. 8D: steps of a method for manufacturing a MEMS component according to the invention;

FIG. 9A: a graph of the temporal variations of the frequency content of an electrical signal of an impulse response obtained by means of the device, according to one embodiment of the invention; and

FIG. 9B: a graph of the temporal variations of the frequency content of an electrical signal of an impulse response obtained by means of the device, according to another embodiment of the invention.

### DETAILED DESCRIPTION OF EMBODIMENTS

The present invention aims in particular at proposing a miniaturised spring reverberation device of the MEMS type.

FIG. 1 shows an exploded view of a device 100 recreating a reverberation effect, and which comprises a hermetic housing 11 composed of a cover 111, preferably transparent, said cover covering a printed circuit 112, a MEMS component 12.

The MEMS component 12, which is not shown in its entirety in FIG. 1 for the sake of readability, comprises a structure 121, a MEMS spring 122, two transducers 123 and 124, each connected respectively to an end 1222-1223 of the MEMS spring 122 by means of a hinge 125. The MEMS spring 122 is composed of a plurality of MEMS cells 1221, one of which is shown with hatching in FIG. 1.

Advantageously, the MEMS spring 122 is a flat spring.

In this exemplary embodiment, the transducers 123 and 124 respectively comprise two piezoelectric blades 1231-1232 and 1241-1242. For example, the blades 1231-1232 and 1241-1242 are made of lead zirconate titanate (PZT).

The printed circuit 112 comprises in particular an input connector 1121, for transmitting an input signal called a “source” signal to the device 100, an output connector 1122 for transmitting a “reverberated” output signal, this reverberated signal typically being transmitted to an external system such as a sound reproduction or recording system. The “source” signal is an electrical signal, itself resulting from a conversion or transduction of a sound signal to which it is desired to add the reverberation effect.

In this example, the transducer 123 is configured to convert an input electrical signal into a mechanical vibration that propagates along the MEMS spring 122, and the transducer 124 is used to convert the mechanical vibrations propagating in the MEMS spring 122 into an output electrical signal, the latter signal comprising several components related to the multiple echoes generated within the MEMS spring 122.

Thus, the transducer 123 is configured to rotationally move the hinge 125, preferably proportional to the input electrical signal.

The transducers 123 and 124 can be used in differential mode, that is to say with a phase shift of +/−π between the blades 1231-1232 and 1241-1242, or in common mode, i.e. with a zero phase shift between the blades 1231-1232 and 1241-1242. In the first case, an operational amplifier can for example be provided to implement this phase shift.

The separation of the common and differential modes can be implemented both at the input and at the output of the device 100.

Finally, the transducers 123 and 124 act as terminating impedances. In order to produce the reverberation effect, that is to say by the presence of echoes in the MEMS spring 122, the mechanical torsion impedances of the transducers 123 and 124 are preferably different from the characteristic mechanical impedance of said spring. In order to model the dynamic behaviour of the device 100, and to size the MEMS component 12, an analogy with the terminating impedances of a transmission line can be made.

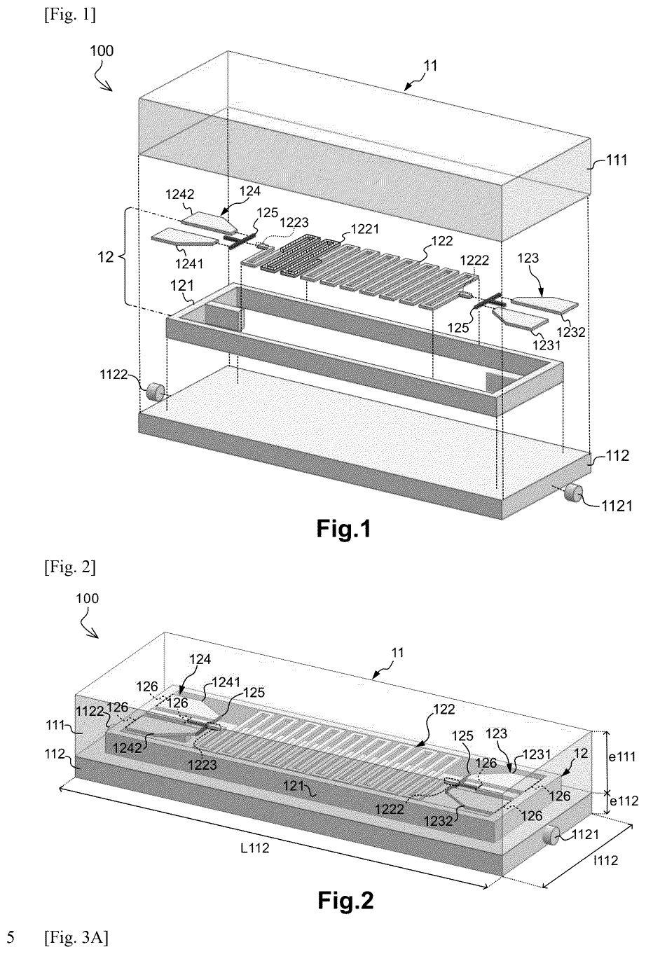

FIG. 2 shows a perspective view of the device 100 and when the housing 11 is completely closed. As for FIG. 1, and for the sake of readability, the MEMS component 12 is not shown as a whole in FIG. 2,

In order to limit the thermoviscous losses inside the housing 11, said losses dissipating the mechanical energy in the MEMS spring 122 when it vibrates, preferably a vacuum between 0.1 Pa and 100 Pa is produced in the housing 11.

In other embodiments, the interior volume of the housing is filled with a gas at a given pressure allowing minimising the thermoviscous losses.

Thus, and by reducing the thermoviscous losses, the quality factor Q, which is defined as being the ratio between the maximum energy contained in a MEMS cell 1221 and the energy which is dissipated by this same cell over an oscillation period, increases. Preferably, and in order to obtain a number of echoes to generate the desired sound effect, it is preferable that the quality factor Q of a MEMS cell 1221 is greater than 100.

As previously specified, the MEMS spring 122 is connected, in a secured manner, at each of the ends 1222-1223 thereof to hinges 125, these hinges being themselves connected in a fixed manner to the transducers 123 and 124. As shown in FIG. 2, the transducers 123 and 124 as well as the hinges 125 are partly embedded on the structure 121 of the MEMS component 12.

These embedded components are represented by the areas 126 in dotted lines in FIG. 2.

Thus, these embedded components will constrain the movements of the transducers 123 and 124 as well as the movements of the hinges 125 to obtain the desired type of vibrations at the MEMS spring 122. Preferably, the MEMS spring 122 is moved by means of the transducer 123 in order to produce torsional movements about its equilibrium position. The blades 1231 and 1232 can be actuated in phase opposition in order to promote this vibration mode of the MEMS spring 122. In other embodiments, the blades 1231 and 1232 are actuated in phase and by applying the same load thereto in order to promote the propagation of a longitudinal and bending vibration mode within the MEMS spring 122.

In order to transmit the input signal to the transducer 123, electrical tracks (not shown here) are present on the printed circuit 112 and connect the input connector 1121 to the transducer 123. The same applies to the output connector 1122 and the transducer 124.

Finally, in a particular exemplary embodiment, the printed circuit 112 has a thickness e112 of 600 μm, a length L112 of less than 10 mm, a width 1112 in the range of 5 mm, and the cover 111 has a thickness e111 of at least 1 mm.

Thus, and due to the used materials and the dimensions thereof, the device 100 is therefore extremely compact and very light, in comparison with the existing reverberation systems which typically use springs having a length of several tens of centimetres. The device 100 also has the particularity of requiring only low electrical consumption, in comparison with the simulated spring reverberations which require powering a digital signal processor (DSP). Moreover, the design of the device 100 allows obtaining a high quality factor.

Advantageously, and thanks to the small dimensions thereof, the device 100 can be directly integrated into sound production systems, such as musical instruments, guitar or bass amplifiers, but also acoustic speakers, or as an additional sound effect in effects pedals.

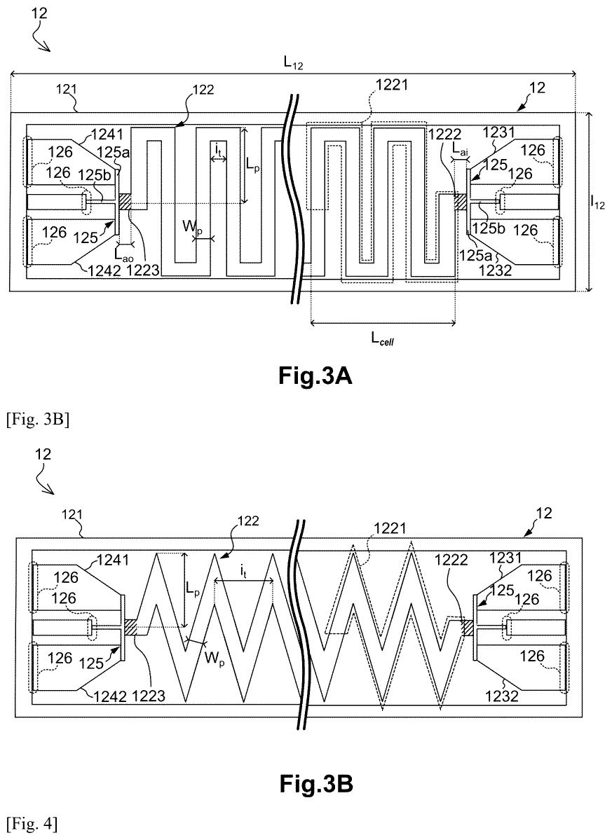

FIG. 3A represents a top view of the MEMS component 12.

For the sake of readability, the device 100 being a miniaturised device, the MEMS component 12 is not represented as a whole in FIG. 3A. In addition, the different elements of the MEMS component 12 are intentionally not represented to scale in order to better identify the dimensioning parameters of the MEMS spring 121.

In addition, the positions of the embedded components of the transducers 123 and 124 as well as the hinges 125 at the areas 126 of the structure 121 are more easily visible in FIG. 3A.

The hinges 125 comprise a connecting rod 125a connecting together a free edge of the blade 1231 with a free edge of the other blade 1232, or a free edge of the blade 1241 with a free edge of the other blade 1242, as well as an embedding rod 125b connecting the support structure 121 to the connecting rod 125a. In the particular exemplary embodiment which is illustrated, the free edge of the blades is a lateral edge.

However, alternatively, the rods 125a, 125b can be provided respectively on a lower edge of the blade 1231 and on a lower edge of the other blade 1232 or respectively on an upper edge

As previously presented, the MEMS spring 121 includes a number n of MEMS cells 1221, one of which is delimited in FIG. 3A by dotted lines.

In one embodiment, the MEMS cell 1221 is formed of one or more rectangular or square-shaped corrugations. Each corrugation can be formed as in FIG. 3A, of a succession of first strips extending in a first direction and connected to each other two by two by second strips in a second direction orthogonal to the first direction. In this figure, a band width Wₚ, an interband space iₜ between two first strips and a half-width Lₚ of the first strips are defined. In the illustrated example, the MEMS cell 1221 has a total length L_{cell} which corresponds to two round trips or two successive corrugations, as shown in FIG. 3A. In addition, the MEMS cell 1221 is defined by a thickness tₘ (not shown here).

The ends 1222 and 1223 of the MEMS spring 121 are characterised respectively by a length Lₐᵢ and a length Lₐₒ.

Preferably, the MEMS spring 121 is sized such that the echoes are produced with a delay dₑ=25 ms, as shown in FIG. 5.

By way of example, and without this presenting a limit to the invention, Table 1 below summarises the dimensions of a MEMS cell 1222 allowing obtaining a delay dₑ=25 ms between two echoes.

TABLE 1

| Parameter | Value |
|---|---|
| MEMS cell thickness, tₘ (μm) | 5 |
| Interband spacing, iₜ (μm) | 5 |
| Width of the band, Wₚ (μm) | 5 |
| MEMS cell half-width, Lₚ (mm) | 1000 |
| Length of the first end of the MEMS spring, Lₐᵢ (μm) | 5 |
| Length of the second end of the MEMS spring, Lₐₒ (μm) | 5 |
| Total length of a MEMS cell, Lₜₒₜ (μm) | 45 |
| Number of MEMS cells, n | 100 |
| Length of the MEMS spring (μm) | 4015 |

Thus, and for the dimensions given in Table 1, the MEMS component 12, which as a reminder is the active portion of the device 100 in which the reverberation effect is generated, has a length L₁₂ which is less than 5 mm, and a width 112 which is less than 3 mm.

More generally, the interband spacing is comprised between 5 and 20 μm, the thickness tm is comprised between 5 and 20 μm, the band width Wp is comprised between 5 and 100 μm, the half-width Lp is comprised between 100 μm and 2 mm.

In other embodiments, the MEMS cell 1221 is formed of a succession of triangular corrugations, as shown in FIG. 3B.

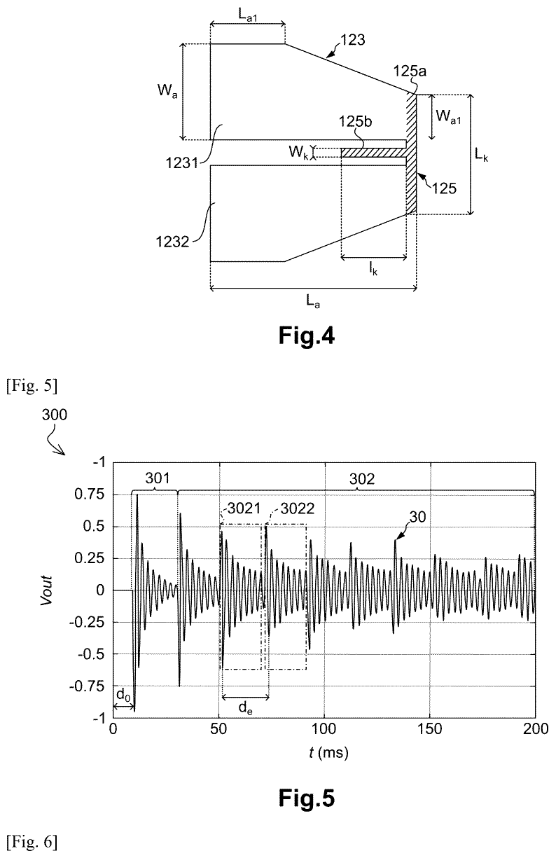

FIG. 4 represents a top view of the transducer 123 and the hinge 125. The following description of FIG. 4 is also valid for the transducer 124. The pentagonal shape of the blades 1231 and 1232 allows lightening the structure and therefore increasing the resonance frequency of these elements in order to widen the bandwidth.

This pentagonal shape is defined by a base width Wₐ, a top width Wₐ₁ which is less than the base width Wₐ, a height Lₐ, and a partial height Lₐ₁.

These dimensions are optimised in order to obtain a maximum displacement or deformation angle of the end of the blades 1231 and 1232, as shown in FIG. 5 in (B) and (C), while minimising the surface area of said blades.

Furthermore, the minimisation of the surface area of the blades 1231-1232 and 1241-1242 contributes to the low energy consumption of the device 100.

The hinge 125, represented by the hatching in FIG. 4, is preferably T-shaped, and is in turn manufactured in the same layer as the blades 1231-1232 and 1241-1242. The hinge is defined by a width Wₖ of the embedding rod 125b, a length lₖ of the embedding rod 125b and a length Lₖ of the connecting rod 125a.

By way of example, and without this presenting a limit to the invention, table 2 below summarises possible dimensions of the transducers 123 and 124 and of the hinge 125.

TABLE 2

| Parameter | Value |
|---|---|
| Blade base width, Wₐ (μm) | 400 |
| Blade top width, Wₐ₁ (μm) | 200 |
| Blade height, Lₐ (μm) | 800 |
| Blade partial height, Lₐ₁ (μm) | 400 |
| Embedding rod width, Wₖ (μm) | 5 |
| Embedding rod length, lₖ (μm) | 200 |
| Connecting rod length, Lₖ (μm) | 415 |

FIG. 5 shows a graph 300 of an output signal 30 of an impulse response obtained by means of the device 100. In this example, an impulse signal is used to illustrate the reverberation effect generated by the device 100.

The abscissa axis represents the time scale t, ranging from 0 to 200 ms, and the ordinate axis represents the relative voltage Vₒᵤₜ of the output signal 30.

The output signal 30 is composed of a first portion 301 which corresponds to the impulse signal which is directly transmitted through the MEMS spring 122, and a second portion 302 in which it is possible to see the multiple echoes which, superimposing themselves, will create the desired reverberation effect.

In FIG. 5, the first delay d₀ corresponds to the time of propagation of the signal through the MEMS spring 122, and the second delay dₑ corresponds to the delay between two successive echoes 3021 and 3022.

By modifying the parameters listed in Table 1, the properties of the MEMS spring 122 can then be optimised to obtain the desired reverberation effect. Thus, and by way of example, the delay dₑ between two successive echoes 3021 and 3022 is directly a function of the number n of MEMS cells 1221: the delay dₑ increases linearly as a function of the number n.

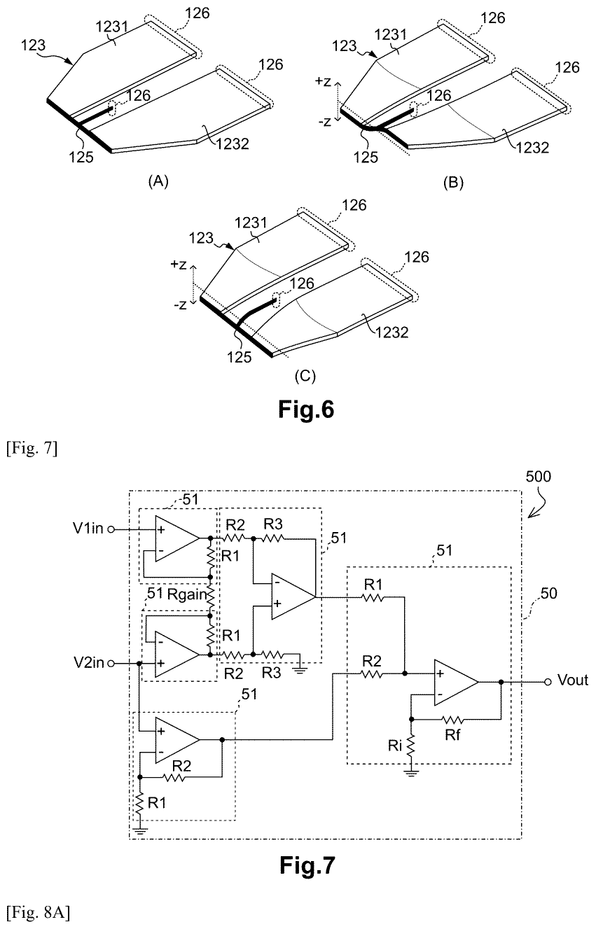

FIG. 6 shows three perspective views of the transducer 123 when it is in different positions in order to illustrate its main vibration modes.

First, FIG. 6 in (A) shows the transducer 123 in its equilibrium position. In this position, the blades 1231 and 1232 are aligned and do not have any deformations related to vibrations.

Then, FIG. 6 in (B) shows the transducer 123, when it vibrates in a so-called “differential” mode, and which corresponds to the propagation in the MEMS spring 122 of a torsion wave. The blades 1231 and 1232 then oscillate in phase opposition around their equilibrium position, seen in (A) and schematised by a dotted line representing an ordinate axis z.

Then, FIG. 6 in (C) shows the transducer 123, when it vibrates in a so-called “common” mode, that is to say a mode where the blades 1231 and 1232 oscillate in phase around their equilibrium position, also schematised here by a dotted line representing an ordinate axis z. The same potential difference is also applied to the blades 1231 and 1232. At the MEMS spring 122, this corresponds to the propagation of a combination of a longitudinal and bending wave

FIG. 7 shows an electrical diagram 500 of an analogue processing assembly 50 comprising differential amplifiers 51 for extracting certain components of the signal produced by the device. This assembly allows using, for example, only the differential vibration mode of the transducer 124, in order to retain only the component of the signal originating from the torsion mode of the MEMS spring 122. In the preferred embodiment of the invention, the analogue processing assembly 50 comprises two inputs receiving the signals V1in and V2in originating respectively from the mechanical-electrical conversions at the blades 1241 and 1242 of the transducer 124.

At the output of the analogue processing assembly 50, an output signal Vout is obtained, as shown in FIG. 5.

In addition, the analogue processing assembly 50 comprises a gain, represented on the electrical diagram 500 by a resistor Rgain and which allows a user to modify the contribution of the torsion and bending modes present in the MEMS spring 122 when it vibrates.

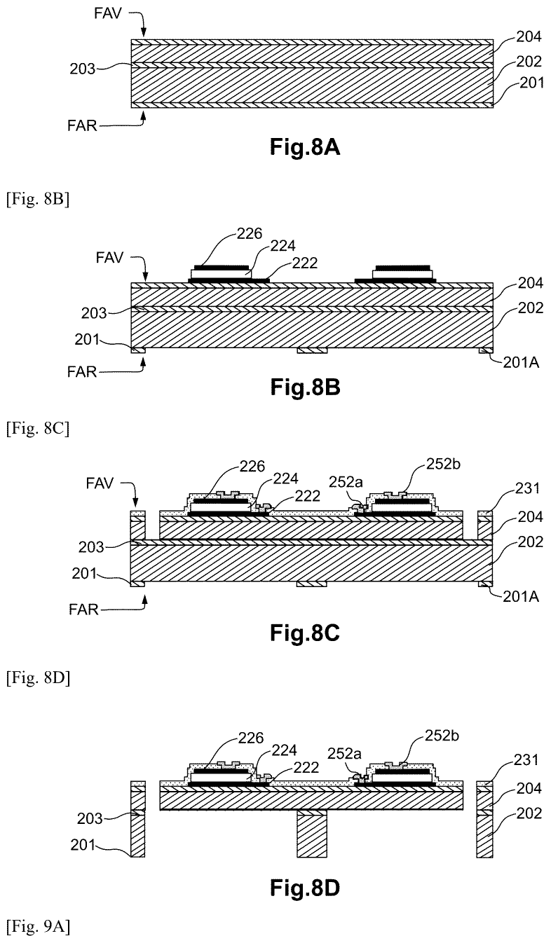

A particular exemplary embodiment of a method for manufacturing a MEMS component 12 as previously described will now be given in connection with FIGS. 8A-8D.

A possible starting structure is illustrated in FIG. 8A, with a wafer of the BESOI type (for “bonding and etch back silicon-on-insulator), including two semiconductor layers 202, 204, superimposed, for example in silicon, here separated by a typically insulating separation layer and for example of silicon oxide 203.

The MEMS spring 122 is intended to be formed in an upper semiconductor layer 204, typically the thinnest of the semiconductor layers 202, 204. Similarly, the hinges 125 of the transducers 123 and 124 can be formed in this layer 204, as well as at least one portion of the anchoring structure 121. It is thus possible to provide for at least partially producing all movable elements in the upper layer 204. The lower semiconductor layer 202 can be provided here to form the frame.

On the thinnest semiconductor layer 204 located on the front face FAV of the plate, a stack comprising:
a first electrode layer 222, for example in Pt;
a layer 224 of piezoelectric material, for example PZT; then
a second electrode layer 226, for example in Pt;
   is deposited.

As illustrated in FIG. 8B, this stack is then structured to form the piezoelectric transducers. The piezoelectric transducers are, in turn, defined by etching. A masking 201A, for example formed from a silicon oxide layer 201 disposed on the rear face FAR, is provided here and also structured with a view to subsequently performing a deep etching step by this rear face FAR.

As illustrated in FIG. 8C, an etching of the silicon layer 204 so as to define the MEMS spring 122 and the hinges 125 of the transducers 123 and 124 is then performed.

Prior to this definition, the transducers are typically protected by a passivation layer 231, for example made of silicon oxide, through which openings are made for electrical contacts 252b, 252a respectively allowing the electrical supply of the upper and lower electrodes of the piezoelectric transducers. A conductive material, for example such as Au, is deposited to form the contacts.

Then, and as illustrated in FIG. 8D, a step of deep etching of the rear face FAR of the plate in order to release the MEMS spring 122 and the deformable structure with the transducers 123 and 124 is then performed. The lower semiconductor layer 202 is thus etched here.

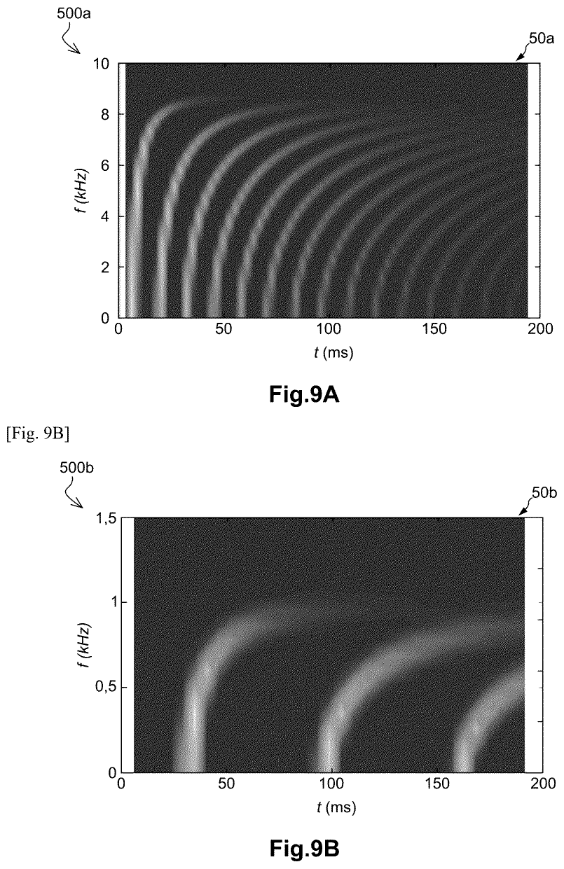

FIG. 9A and FIG. 9B respectively show a graph 500a and a graph 500b which illustrate examples of the temporal variations of the frequency contents 50a and 50b of electrical signals of impulse responses obtained by means of the device according to two distinct embodiments of the invention.

FIG. 9A is the spectrogram obtained for a device 100 including 200 MEMS cells 1221.

FIG. 9B is the spectrogram obtained for a device 100 including 100 MEMS cells 1221.

In FIGS. 9A and 9B, the dispersive effect can be seen in particular along the time axis t, where the propagation time within the device 100 differs as a function of the frequency f.

1. A micro-electromechanical device (100) for distorting an electrical signal to recreate a sound reverberation effect including:
an input connector (1121) for an incoming electrical signal;
an output connector (1122) for an outgoing electrical signal;
an input electromechanical transducer (123) coupled to the input connector (1121);
an output electromechanical transducer (124) coupled to the output connector (1122);
a support structure (121);
said device being provided with a MEMS spring (122) including a first end (1222), a second end (1223), the first end and the second end being connected respectively to the input electromechanical transducer (123) by means of a hinge (125) to the output electromechanical transducer (124) by means of another hinge (125), the input electromechanical transducer (123), the output electromechanical transducer (124) and the hinges (125) being partially embedded on the support structure (121), the input electromechanical transducer (123) being configured to move the hinge (125).

2. The device according to claim 1, wherein the input electromechanical transducer (123) and/or the output electromechanical transducer (124) include(s) two blades (1231, 1232, 1241, 1242), in particular coplanar, configured to apply a torsional torque to the hinge

3. The device according to claim 2, wherein the blades (1231, 1232, 1241, 1242) are piezoelectric elements.

4. The device according to claim 2, wherein the incoming electrical signal is transmitted on one of the blades (1231, 1232) of the input electromechanical transducer (123), while said incoming electrical signal is transmitted in phase opposition on the other blade (1231, 1232) of said transducer.

5. The device according to claim 1, wherein the hinge (125) comprises a connecting rod (125a) connecting together one edge of a blade (1231, 1241) with another edge of the other blade (1232, 1242) and an embedding rod (125b) connecting the support structure (121) to the connecting rod (125a).

6. The device according to claim 1, wherein the MEMS spring (122) is a flat spring, which when said spring is at rest, extends between the first end (1222) and the second end (1223) in the same plane.

7. The device according to claim 1, wherein the MEMS spring (122) is formed of a succession of MEMS cells (1221), each cell forming one or more undulations, advantageously rectangular or triangular, the succession of cells forming a succession of undulations.

8. The device according to claim 7, wherein each MEMS cell (1221) is defined by a thickness (tm) comprised between 5 and 20 μm, a band width (Wp) comprised between 5 and 100 μm, a half-width (Lp) comprised between 100 μm and 2 mm, and an interband spacing (it) comprised between 5 and 20 μm.

9. The device according to claim 7, wherein the MEMS cells (1221) have dimensions which depend on their position along the MEMS spring (122).

10. The device according to claim 9, further comprising at least one hermetic housing (11) wherein the support structure (121), the input (123) and output (124) transducers and the MEMS spring (122) are housed, the pressure inside the housing (11) being advantageously comprised between 0.1 Pa and 100 Pa.

11. The device according to claim 10, further comprising: a printed circuit (112) on which the support (121) structure (122) and an analogue processing circuit (50) connected to the output connector (1122) are arranged.

12. A sound production system characterised in that it comprises a micro-electromechanical device (100) for recreating a reverberation effect according to claim 1.

13. A method for manufacturing a device according to claim 1, comprising the following steps:
providing a support, comprising, from the rear face (FAR) thereof to the front face (FAV) thereof which is opposite the rear face: at least one first semiconductor layer (201) and a second semiconductor layer (202) which are superimposed, and coating the support with a stack comprising a first conductive layer (222), a piezoelectric material layer (224) and a second conductive layer (226),
structuring the stack and the second semiconductor layer (204) of the support so as to produce the input (123) and output (124) transducer in said stack as well as the hinges (125) and the MEMS spring (122) in the second semiconductor layer (204),
etching the first semiconductor layer (202) by the rear face (FAR) of the support so as to release the MEMS spring (122), the hinges (125) and the input (123) and output (124) transducers.
